(19) United States
(12) Patent Application Publication
(10) Pub. No.: US 2023/0395820 A1
(43) Pub. Date: Dec. 7, 2023

(54) DEVICE AND METHOD

(71) Applicant: TRIPOD DESIGN CO., LTD., Tokyo (JP)

(72) Inventor: Satoshi NAKAGAWA, Tokyo (JP)

(73) Assignee: TRIPOD DESIGN CO., LTD., Tokyo (JP)

(21) Appl. No.: 18/032,254

(22) PCT Filed: Aug. 11, 2021
(86) PCT No.: PCT/JP2021/029681

§ 371 Date: Apr. 17, 2023

(30) Foreign Application Priority Data
Oct. 19, 2020 (JP) 2020-175672

(51) Int. Cl. H01M 6/42; H01M 6/04; H01M 6/50

(52) U.S. Cl. CPC H01M 6/42; H01M 6/045; H01M 6/50

(57) ABSTRACT

An object is to provide a device that operates on a self sustaining power source. A device comprising that operates on a self-sustaining power source includes: 2n electrodes (n is an integer of 2 or more) from a first electrode to a 2n-th electrode; and a medium present between a (2k−1)-th electrode (k is an integer of 1 or more and less than n) and a 2k-th electrode and between a (2n−1)-th electrode and the 2n-th electrode. The 2k-th electrode is connected to a (2k+1)-th electrode, and an impedance between a point in the medium between the (2k−1)-th electrode and the 2k-th electrode and a point in the medium between the (2k+1)-th electrode and a (2k+2)-th electrode is greater than or equal to 5 times each of an impedance between the (2k−1)-th electrode and the 2k-th electrode and an impedance between the (2k+1)-th electrode and the (2k+2)-th electrode.

### TECHNICAL FIELD

The present invention relates to a device that operates on a self-sustaining power source and a method.

### BACKGROUND ART

There is a device in which two different kinds of metals are used as electrodes and immersed in an electrolytic solution to cause an oxidation reaction or a reduction reaction in each electrode to create a path through which electrons flow (that is, a battery), such as a voltaic battery or a Daniels battery.

A liquid used as an electrolytic solution of a battery may adversely affect a human body and an environment, such as fear of chemical burn, fear of fire or explosion, or generation of toxic gas, and thus handling of the electrolytic solution is very difficult. In addition, there is a problem in that it is necessary to prevent liquid leakage at the time of commercialization, and the cost increases.

Meanwhile, in recent years, energy harvesting technology that converts minute energy such as visible light, heat, radio waves, or organic matter decomposition processing by microorganisms into electric power has attracted attention, and research has been conducted to put a self-sustaining power source into practical use by using the energy harvesting technology.

As for self-sustaining power source, there are many cases where a voltage to be output is small. Therefore, a high voltage is obtained by connecting in series respective voltage generating cells, which are completely separated from each other. As a result, characteristics of the energy harvesting technology such as small size and light weight are limited.

### SUMMARY OF INVENTION

### Technical Problem

At least one object of the present invention is to provide a device that operates on a self-sustaining power source, and a method of operating the device.

### Solution to Problem

The present invention solves the above problem by any of the following [1] to [14].

[1] A device comprising: 2n electrodes (n is an integer of 2 or more) from a first electrode to a 2n-th electrode; and a medium present between a (2k−1)-th electrode (k is an integer of 1 or more and less than n) and a 2k-th electrode and between a (2n−1)-th electrode and the 2n-th electrode, wherein the 2k-th electrode is connected to a (2k+1)-th electrode, and an impedance between a point in the medium between the (2k−1)-th electrode and the 2k-th electrode and a point in the medium between the (2k+1)-th electrode and a (2k+2)-th electrode is greater than or equal to 5 times each of an impedance between the (2k−1)-th electrode and the 2k-th electrode and an impedance between the (2k+1)-th electrode and the (2k+2)-th electrode;

[2] The device according to [1], wherein a substance constituting the (2k−1)-th electrode and/or the (2n−1)-th electrode has a standard electrode potential different from a standard electrode potential of a substance constituting the 2k-th electrode and/or the 2n-th electrode;

[3] The device according to [1] or [2], wherein a distance between the point in the medium between the (2k−1)-th electrode and the 2k-th electrode and the point in the medium between the (2k+1)-th electrode and the (2k+2)-th electrode is greater than or equal to 5 times each of a distance between the (2k−1)-th electrode and the 2k-th electrode and a distance between the (2k+1)-th electrode and the (2k+2)-th electrode;

[4] The device according to any one of [1] to [3], wherein the medium is water;

[5] The device according to [4], wherein the medium has an electrolyte concentration of 1.0 mol/1 or less;

[6] The device according to any one of [1] to [5], wherein the medium is soil or sand having a water content of 3% by mass or more;

[7] A device comprising: 2n electrodes (n is an integer of 2 or more) from a first electrode to a 2n-th electrode; and a functional part, wherein when a 2k-th electrode (k is an integer of 1 or more and less than n) is connected to a (2k+1)-th electrode, a medium is present between a (2k−1)-th electrode and the 2k-th electrode, and a medium is present between the (2k+1)-th electrode and a (2k+2)-th electrode, the functional part functions when an impedance between a point in the medium between the (2k−1)-th electrode and the 2k-th electrode and a point in the medium between the (2k+1)-th electrode and the (2k+2)-th electrode is made greater than or equal to 5 times each of an impedance between the (2k−1)-th electrode and the 2k-th electrode and an impedance between the (2k+1)-th electrode and the (2k+2)-th electrode;

[8] A method of causing a device to function, the device including 2n electrodes (n is an integer of 2 or more) from a first electrode to a 2n-th electrode, and a functional part, the method comprising, when a 2k-th electrode (k is an integer of 1 or more and less than n) is connected to a (2k+1)-th electrode, a medium is present between a (2k−1)-th electrode and the 2k-th electrode, and a medium is present between the (2k+1)-th electrode and a (2k+2)-th electrode, causing the functional part to function when an impedance between a point in the medium between the (2k−1)-th electrode and the 2k-th electrode and a point in the medium between the (2k+1)-th electrode and the (2k+2)-th electrode is made greater than or equal to 5 times each of an impedance between the (2k−1)-th electrode and the 2k-th electrode and an impedance between the (2k+1)-th electrode and the (2k+2)-th electrode;

[9] A device comprising: 2n electrodes (n is an integer of 2 or more) from a first electrode to a 2n-th electrode; and a medium present between a (2k−1)-th electrode (k is an integer of 1 or more and less than n) and a 2k-th electrode and between a (2n−1)-th electrode and the 2n-th electrode, wherein the 2k-th electrode is connected to a (2k+1)-th electrode, and a distance between a point in the medium between the (2k−1)-th electrode and the 2k-th electrode and a point in the medium between the (2k+1)-th electrode and a (2k+2)-th electrode is greater than or equal to 5 times each of a distance between the (2k−1)-th electrode and the 2k-th electrode and a distance between the (2k+1)-th electrode and the (2k+2)-th electrode;

[10] A device comprising: 2n electrodes (n is an integer of 2 or more) from a first electrode to a 2n-th electrode; and a functional part, wherein when a 2k-th electrode (k is an integer of 1 or more and less than n) is connected to a (2k+1)-th electrode, a medium is present between a (2k−1)-th electrode (k is an integer of 1 or more and less than n) and the 2k-th electrode, and a medium is present between a (2n−1)-th electrode and the 2n-th electrode, the functional part functions when a distance between a point in the medium between the (2k−1)-th electrode and the 2k-th electrode and a point in the medium between the (2k+1)-th electrode and a (2k+2)-th electrode is made greater than or equal to 5 times each of a distance between the (2k−1)-th electrode and the 2k-th electrode and a distance between the (2k+1)-th electrode and the (2k+2)-th electrode;

[11] A method of causing a device to function, the device including 2n electrodes (n is an integer of 2 or more) from a first electrode to a 2n-th electrode, and a functional part, the method comprising, when a 2k-th electrode (k is an integer of 1 or more and less than n) is connected to a (2k+1)-th electrode, a medium is present between a (2k−1)-th electrode and the 2k-th electrode, and a medium is present between the (2k+1)-th electrode and a (2k+2)-th electrode, causing the functional part to function when a distance between a point in the medium between the (2k−1)-th electrode and the 2k-th electrode and a point in the medium between the (2k+1)-th electrode and the (2k+2)-th electrode is made greater than or equal to 5 times each of a distance between the (2k−1)-th electrode and the 2k-th electrode and a distance between the (2k+1)-th electrode and the (2k+2)-th electrode;

[12] A device comprising: at least four electrodes from a first electrode to a fourth electrode; a medium present between the first electrode and the second electrode; and a medium present between the third electrode and the fourth electrode, wherein the second electrode is connected to the third electrode, and an impedance between a point in the medium between the first electrode and the second electrode and a point in the medium between the third electrode and the fourth electrode is greater than or equal to 5 times each of an impedance between the first electrode and the second electrode and an impedance between the third electrode and the fourth electrode;

[13] A device comprising: at least four electrodes from a first electrode to a fourth electrode; and a functional part, wherein when the second electrode is connected to the third electrode, a medium is present between the first electrode and the second electrode, and a medium is present between the third electrode and the fourth electrode, the functional part functions when an impedance between a point in the medium between the first electrode and the second electrode and a point in the medium between the third electrode and the fourth electrode is made greater than or equal to 5 times each of an impedance between the first electrode and the second electrode and an impedance between the third electrode and the fourth electrode;

[14] A method of causing a device to function, the device including at least four electrodes from a first electrode to a fourth electrode, and a functional part, the method comprising, when the second electrode is connected to the third electrode, a medium is present between the first electrode and the second electrode, and a medium is present between the third electrode and the fourth electrode, causing the functional part to function when an impedance between a point in the medium between the first electrode and the second electrode and a point in the medium between the third electrode and the fourth electrode is made greater than or equal to 5 times each of an impedance between the first electrode and the second electrode and an impedance between the third electrode and the fourth electrode.

### Advantageous Effects of Invention

According to the present invention, it is possible to provide a device that operates on a self-sustaining power source.

### BRIEF DESCRIPTION OF DRAWINGS

FIG. 1 is a diagram illustrating a configuration of a device corresponding to at least one of embodiments of the present invention.

FIG. 2 is a diagram illustrating a configuration of a device corresponding to at least one of the embodiments of the present invention.

FIG. 3 is a diagram illustrating a configuration of a device corresponding to at least one of the embodiments of the present invention.

### DESCRIPTION OF EMBODIMENTS

Hereinafter, embodiments of the present invention will be described with reference to the accompanying drawings. Hereinafter, the description regarding effects is an aspect of the effects of the embodiments of the present invention, and is not limited to the description herein.

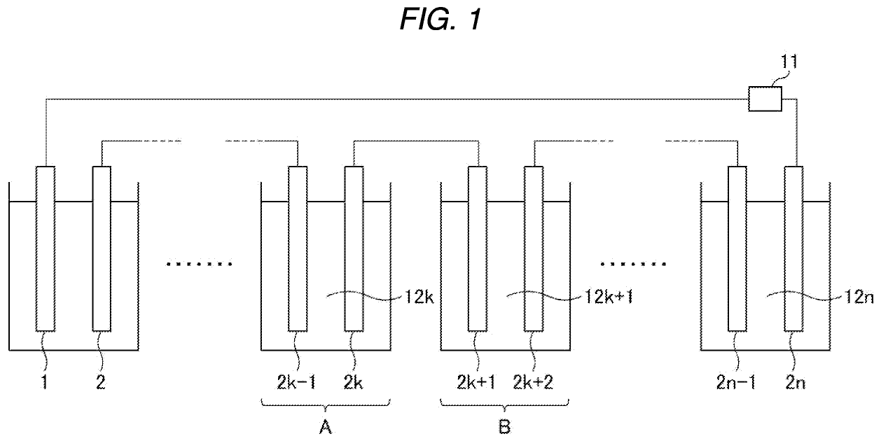

FIG. 1 is a diagram illustrating a configuration of a device corresponding to at least one of the embodiments of the present invention. As illustrated in FIG. 1, the present invention relates to a device including 2n electrodes from a first electrode to a 2n-th electrode, and a medium present between a (2k−1)-th electrode and a 2k-th electrode and between a (2n−1)-th electrode and the 2n-th electrode, in which the 2k-th electrode is connected to a (2k+1)-th electrode, and an impedance between a point in the medium between the (2k−1)-th electrode and the 2k-th electrode and a point in the medium between the (2k+1)-th electrode and a (2k+2)-th electrode is greater than or equal to 5 times each of an impedance between the (2k−1)-th electrode and the 2k-th electrode and an impedance between the (2k+1)-th electrode and the (2k+2)-th electrode.

The device of the present invention includes the 2n electrodes. n is any integer of 2 or more, and is not particularly limited. k can take any integer value of 1 or more and less than n. That is, k can take any integer value between 1 and n−1, inclusive. For example, if n=3, the device includes a first electrode to a sixth electrode, and k can take a value from 1 to 2. If n=4, the device includes a first electrode to an eighth electrode, and k can take a value from 1 to 3.

The (2k−1)-th electrode and the 2k-th electrode constitute a pair of electrodes, and the (2n−1)-th electrode and the 2n-th electrode constitute a pair of electrodes. A medium 12 is present between the (2k−1)-th electrode and the 2k-th electrode and between the (2n−1)-th electrode and the 2n-th electrode. That is, each of media 12₁ to 12ₙ is present between the first electrode and the second electrode, between the third electrode and the fourth electrode, . . . , between a (2k−3)-th electrode and a (2k−2)-th electrode, between the (2k−1)-th electrode and the 2k-th electrode, between the (2k+1)-th electrode and the (2k+2)-th electrode, . . . , and between the (2n−1)-th electrode and the 2n-th electrode.

In addition, the 2k-th electrode is connected to the (2k+1)-th electrode. That is, the second electrode is connected to the third electrode, the fourth electrode is connected to the fifth electrode, . . . , the (2k−2)-th electrode is connected to the (2k−1)-th electrode, the 2k-th electrode is connected to the (2k+1)-th electrode, . . . , and a (2n−2)-th electrode is connected to the (2n−1)-th electrode. That is, in a pair of adjacent electrodes, the even-numbered electrode is connected to the odd-numbered electrode whose number is larger than this even-numbered electrode by one. In addition, the first electrode and the 2n-th electrode may be connected to a functional part. Note that the (2k−1)-th electrode is not connected to the 2k-th electrode by a conductor or the like having conductivity.

Note that the medium 12 may be housed in a container such as an acrylic container. A material of the container or the like that houses the medium 12 is not particularly limited.

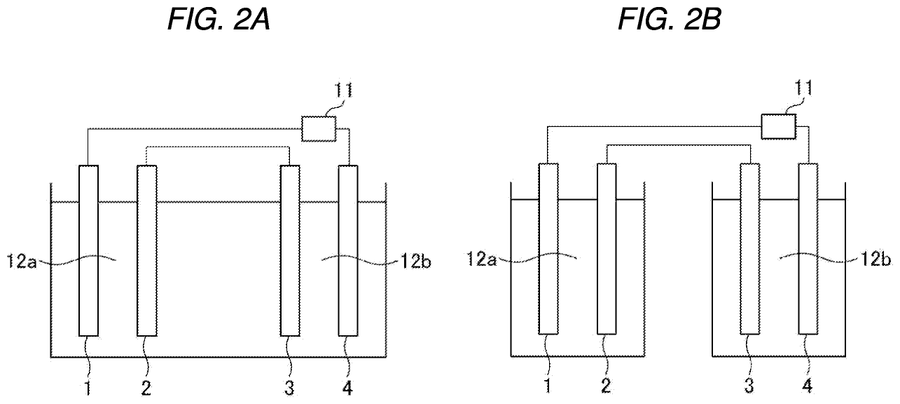

FIG. 2 is a diagram illustrating a configuration of a device corresponding to at least one of the embodiments of the present invention. FIG. 2 illustrates the device configured in the case of n=2. As illustrated in FIG. 2, the device includes a first electrode 1, a second electrode 2, a third electrode 3, a fourth electrode 4, a functional part 11, and a medium 12. The second electrode 2 is electrically connected to the third electrode 3. That is, a pair of electrodes of the first electrode 1 and the second electrode 2 is connected in series to a pair of electrodes of the third electrode 3 and the fourth electrode 4. In addition, both the first electrode 1 and the fourth electrode are electrically connected to the functional part 11. The term “electrically connected” means, for example, energizably connected by a conductive wire or the like having conductivity. A medium 12a is present between the first electrode 1 and the second electrode 2, and a medium 12b is present between the third electrode 3 and the fourth electrode.

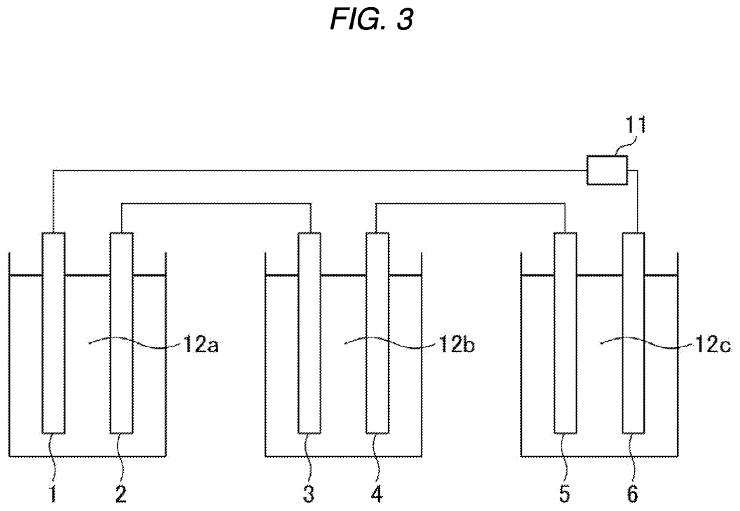

FIG. 3 is a diagram illustrating a configuration of a device corresponding to at least one of the embodiments of the present invention. FIG. 3 illustrates the device configured in the case of n=3. As illustrated in FIG. 3, the device includes, for example, a first electrode 1, a second electrode 2, a third electrode 3, a fourth electrode 4, a fifth electrode 5, a sixth electrode 6, a functional part 11, and a medium 12.

In this case, the second electrode 2 is electrically connected to the third electrode 3, and the fourth electrode 4 is electrically connected to the fifth electrode 5. In addition, both the first electrode 1 and the sixth electrode 6 are electrically connected to the functional part 11. A pair of electrodes of the first electrode 1 and the second electrode 2 is connected in series to a pair of electrodes of the third electrode 3 and the fourth electrode 4 and a pair of electrodes of the fifth electrode 5 and the sixth electrode 6. A medium 12a is present between the first electrode 1 and the second electrode 2, a medium 12b is present between the third electrode 3 and the fourth electrode, and a medium 12c is present between the fifth electrode 5 and the sixth electrode 6.

As described above, the number of pairs of electrodes connected in series to the pair of electrodes of the first electrode 1 and the second electrode 2 is an integer of 1 or more. As the number of pairs of electrodes connected in series to the pair of electrodes of the first electrode 1 and the second electrode 2 (hereinafter, the pair of electrodes connected in series to the pair of the first electrode 1 and the second electrode 2 is referred to as a “pair of electrodes connected in series”) increases, a voltage applied to the functional part 11 also increases.

The first electrode 1 and the second electrode 2 are partially or wholly in contact with the medium 12, but the first electrode 1 and the second electrode 2 are not in contact with each other. Similarly, the (2k−1)-th electrode and the 2k-th electrode, and the (2n−1)-th electrode and the 2n-th electrode (that is, the respective electrodes of the pair of electrodes connected in series) are partially or wholly in contact with the medium 12, but the respective electrodes of the pair of electrodes connected in series are not in contact with each other. The term “not in contact” refers to, for example, a state in which one electrode and another electrode are not in direct contact with each other.

The medium 12 is present between the first electrode 1 and the second electrode 2. As illustrated in FIG. 2A, the first medium 12a present between the first electrode 1 and the second electrode 2 may be physically continuous with and formed integrally with the second medium 12b present between the third electrode 3 and the fourth electrode 4. In addition, as illustrated in FIG. 2B, the first medium 12a present between the first electrode 1 and the second electrode 2 may be physically discontinuous with and formed separately from the second medium 12b present between the third electrode 3 and the fourth electrode 4 without being in contact with the second medium 12b.

The same applies to a case where there are a plurality of pairs of electrodes connected in series. The medium 12 present between the (2k−1)-th electrode and the 2k-th electrode, and the medium 12 present between a pair of electrodes different from the pair of electrodes of the (2k−1)-th electrode and the 2k-th electrode (for example, a pair of electrodes adjacent to the pair of electrodes of the (2k−1)-th electrode and the 2k-th electrode) may be physically continuous with and formed integrally with each other, or may be physically discontinuous with and formed separately from each other. The medium 12 present between the (2n−1)-th electrode and the 2n-th electrode and the medium 12 present between a pair of electrodes different from the (2n−1)-th and the 2n-th electrodes may also be physically continuous with and formed integrally with each other, or may be physically discontinuous with and formed separately from each other.

Each electrode is not limited to a particular shape, but, for example, is preferably a cylindrical or prismatic shape. Each electrode is also not limited to a particular size.

As illustrated in FIG. 1, an impedance between two points in a medium 12ₖ (k is an integer of 1 or more and less than n) present between electrodes of a pair of electrodes A connected in series to the pair of the first electrode 1 and the second electrode 2 and a medium 12ₖ₊₁ present between electrodes of a pair of electrodes B adjacent to the pair of electrodes A connected in series (that is, an impedance between media present between electrodes of two adjacent pairs of electrodes) is configured to be greater than or equal to 5 times an impedance of the medium 12ₖ between the electrode and the electrode of the pair of electrodes A, and is configured to be greater than or equal to 5 times an impedance of the medium 12ₖ₊₁ between the electrode and the electrode of the pair of electrodes B. Examples of a method of achieving such a configuration include a method of appropriately adjusting a distance between the electrodes in the pair of electrodes according to the type of the medium, and a method of appropriately adjusting a distance between the two adjacent pairs of electrodes.

That is, the impedance between the point in the medium 12ₖ between the (2k−1)-th electrode and the 2k-th electrode and the point in the medium 12ₖ₊₁ between the (2k+1)-th electrode and the (2k+2)-th electrode is configured to be greater than or equal to 5 times each of the impedance of the medium 12ₖ between the (2k−1)-th electrode and the 2k-th electrode and the impedance of the medium 12ₖ₊₁ between the (2k+1)-th electrode and the (2k+2)-th electrode. The impedance between the point in the medium 12ₖ between the (2k−1)-th electrode and the 2k-th electrode and the point in the medium 12ₖ₊₁ between the (2k+1)-th electrode and the (2k+2)-th electrode is preferably greater than or equal to 50 times, more preferably greater than or equal to 250 times, still more preferably greater than or equal to 500 times, and particularly preferably greater than or equal to 1000 times each of the impedance of the medium 12ₖ between the (2k−1)-th electrode and the 2k-th electrode and the impedance of the medium 12ₖ₊₁ between the (2k+1)-th electrode and the (2k+2)-th electrode. Since the impedance between the point in the medium 12ₖ between the (2k−1)-th electrode and the 2k-th electrode and the point in the medium 12ₖ₊₁ between the (2k+1)-th electrode and the (2k+2)-th electrode is greater than or equal to 5 times the impedance thereof, a voltage necessary for causing the functional part 11 to function can be applied.

Making the impedance between the point in the medium 12ₖ between the (2k−1)-th electrode and the 2k-th electrode and the point in the medium 12ₖ₊₁ between the (2k+1)-th electrode and the (2k+2)-th electrode greater than or equal to 5 times each of the impedance of the medium 12ₖ between the (2k−1)-th electrode and the 2k-th electrode and the impedance of the medium 12ₖ₊₁ between the (2k+1)-th electrode and the (2k+2)-th electrode can be achieved by adjusting a distance between the point in the medium 12ₖ between the (2k−1)-th electrode and the 2k-th electrode and the point in the medium 12ₖ₊₁ between the (2k+1)-th electrode and the (2k+2)-th electrode, a distance between the (2k−1)-th electrode and the 2k-th electrode, and a distance between the (2k+1)-th electrode and the (2k+2)-th electrode. For example, there is a method of making the distance between the point in the medium 12ₖ between the (2k−1)-th electrode and the 2k-th electrode and the point in the medium 12ₖ₊₁ between the (2k+1)-th electrode and the (2k+2)-th electrode greater than or equal to 5 times the distance between the (2k−1)-th electrode and the 2k-th electrode and the distance between the (2k+1)-th electrode and the (2k+2)-th electrode.

The distance between the point in the medium 12ₖ between the (2k−1)-th electrode and the 2k-th electrode and the point in the medium 12ₖ₊₁ between the (2k+1)-th electrode and the (2k+2)-th electrode is preferably greater than or equal to 5 times, more preferably greater than or equal to 10 times, still more preferably greater than or equal to 15 times, and particularly preferably greater than or equal to 30 times the distance between the (2k−1)-th electrode and the 2k-th electrode and the distance between the (2k+1)-th electrode and the (2k+2)-th electrode.

As another method of making the impedance between the point in the medium 12ₖ between the (2k−1)-th electrode and the 2k-th electrode and the point in the medium 12ₖ₊₁ between the (2k+1)-th electrode and the (2k+2)-th electrode greater than or equal to 5 times each of the impedance of the medium 12ₖ between the (2k−1)-th electrode and the 2k-th electrode and the impedance of the medium 12ₖ+1 between the (2k+1)-th electrode and the (2k+2)-th electrode, there is a method of electrically insulating the medium 12ₖ between the (2k−1)-th electrode and the 2k-th electrode and the medium 12ₖ₊₁ between the (2k+1)-th electrode and the (2k+2)-th electrode from each other by using any insulator of a solid, a gas, or a liquid. Specifically, there is a method of using a plurality of insulating containers to dispose the (2k−1)-th electrode, the 2k-th electrode, and the medium 12ₖ in a container different from a container in which the (2k+1)-th electrode, the (2k+2)-th electrode, and the medium 12ₖ₊₁ are disposed.

Here, the impedance between the point in the medium 12ₖ between the (2k−1)-th electrode and the 2k-th electrode and the point in the medium 12ₖ₊₁ between the (2k+1)-th electrode and the (2k+2)-th electrode is an impedance between two points of any point in the medium 12ₖ and any point in the medium 12ₖ₊₁, for example, an impedance between two points of a point corresponding to the middle between the (2k−1)-th electrode and the 2k-th electrode and a point corresponding to the middle between the (2k+1)-th electrode and the (2k+2)-th electrode.

The impedance between the point in the medium 12ₖ between the (2k−1)-th electrode and the 2k-th electrode and the point in the medium 12ₖ₊₁ between the (2k+1)-th electrode and the (2k+2)-th electrode is preferably greater than or equal to 10 kΩ, more preferably greater than or equal to 50 kΩ, still more preferably greater than or equal to 100 kΩ, and particularly preferably greater than or equal to 200 kΩ, In addition, the impedance between the point in the medium 12ₖ between the (2k−1)-th electrode and the 2k-th electrode and the point in the medium 12ₖ₊₁ between the (2k+1)-th electrode and the (2k+2)-th electrode is preferably smaller than or equal to 50,000 kΩ, more preferably smaller than or equal to 15,000 kΩ, still more preferably smaller than or equal to 5,000 kΩ, and particularly preferably smaller than or equal to 1,500 kΩ.

The impedance of the medium 12ₖ between the (2k−1)-th electrode and the 2k-th electrode and an impedance of the medium 12ₙ between the (2n−1)-th electrode and the 2n-th electrode are preferably greater than or equal to 0.01 kΩ, more preferably greater than or equal to 0.1 kΩ, still more preferably greater than or equal to 0.3 kΩ, and particularly preferably greater than or equal to 0.5 kΩ. In addition, the impedance of the medium 12ₖ between the (2k−1)-th electrode and the 2k-th electrode and the impedance of the medium 12n between the (2n−1)-th electrode and the 2n-th electrode are preferably smaller than or equal to 150 kΩ, more preferably smaller than or equal to 50 kΩ, still more preferably smaller than or equal to 15 kΩ, and particularly preferably smaller than or equal to 5 kΩ. Note that the impedance of the medium 12ₖ between the (2k−1)-th electrode and the 2k-th electrode may have different values or the same value for each medium 12 between the electrodes.

In a case where each electrode has a cylindrical or prismatic shape, the paired electrodes including the first electrode 1 and the second electrode 2 are preferably arranged such that length directions of the electrodes are substantially parallel. A preferred shortest distance between the paired electrodes differs depending on the medium 12 present between the electrodes.

When the medium 12 is pure water or has an electrolyte concentration of 1.0 mol/L or less, the shortest distance between the paired electrodes is preferably greater than or equal to 0.1 cm, more preferably greater than or equal to 0.3 cm, and still more preferably greater than or equal to 1.0 cm. In addition, in a case where the medium 12 is soil or sand having a water content of 3% by mass, the shortest distance between the paired electrodes is preferably smaller than or equal to 15 cm, more preferably smaller than or equal to 10 cm, and still more preferably smaller than or equal to 5 cm. By setting the shortest distance to a predetermined range, the impedance of the medium 12 present between the paired electrodes can be set to the above range.

As illustrated in FIG. 2A, in a case where the medium 12 is physically continuously and integrally formed, and the medium 12 is pure water or has an electrolyte concentration of 1.0 mol/L or less, a shortest distance between the pair of electrodes connected in series and the pair of electrodes adjacent to the aforementioned pair of electrodes is preferably greater than or equal to 5 cm, more preferably greater than or equal to 15 cm, and still more preferably greater than or equal to 30 cm. In addition, in this case, the shortest distance between the pair of electrodes connected in series and the pair of electrodes adjacent to the aforementioned pair of electrodes is preferably smaller than or equal to 1,000 m, more preferably smaller than or equal to 100 m, and still more preferably smaller than or equal to 10 m. By setting the shortest distance to a predetermined range, the impedance between the media 12 corresponding to the respective pairs of electrodes in the two adjacent pairs of electrodes can be set to the above range.

In a case where the medium 12 is soil or sand having a water content of 3% by mass or more, the shortest distance between the paired electrodes is preferably greater than or equal to 0.1 cm, more preferably greater than or equal to 0.3 cm, and still more preferably greater than or equal to 1.0 cm. In addition, in a case where the medium 12 is soil or sand having a water content of 3% by mass, the shortest distance between the paired electrodes is preferably smaller than or equal to 10 cm, more preferably smaller than or equal to 5 cm, and still more preferably smaller than or equal to 3 cm. By setting the shortest distance to a predetermined range, the impedance of the medium 12 present between the paired electrodes can be set to the above range.

As illustrated in FIG. 2A, in a case where the medium 12 is physically continuously and integrally formed, and the medium 12 is soil or sand having a water content of 3% by mass or more, the shortest distance between the pair of electrodes connected in series and the pair of electrodes adjacent to the aforementioned pair of electrodes is preferably greater than or equal to 5 cm, more preferably greater than or equal to 15 cm, and still more preferably greater than or equal to 30 cm. In addition, in this case, the shortest distance between the pair of electrodes connected in series and the pair of electrodes adjacent to the aforementioned pair of electrodes is preferably smaller than or equal to 1,000 m, more preferably smaller than or equal to 100 m, and still more preferably smaller than or equal to 10 m. By setting the shortest distance to a predetermined range, the impedance between the media 12 corresponding to the respective pairs of electrodes in the two adjacent pairs of electrodes can be set to the above range.

Each of the paired electrodes has conductivity. Here, for example, a metal, a conductive polymer, carbon, or the like is used as a material of each electrode. The metal used for each electrode can be appropriately selected from, for example, silver, copper, gold, aluminum, magnesium, zinc, nickel, platinum, tin, titanium, stainless steel, zinc oxide, magnesium oxide, oxides of the above-described metals, and the like. In addition, a certain metal may be coated with another metal different from the certain metal or another material having conductivity.

As the paired electrodes, electrodes having different standard electrode potentials are preferably used. In a case where different substances are used for the (2k−1)-th electrode and the 2k-th electrode, and different substances are used for the (2n−1)-th electrode and the 2n-th electrode, a substance having a lower standard electrode potential can be used for the (2k−1)-th electrode and the (2n−1) electrode, and a substance having a higher standard electrode potential can be used for the 2k-th electrode and the 2n-th electrode. On the other hand, in a case where different substances are used for the (2k−1)-th electrode and the 2k-th electrode, and different substances are used for the (2n−1)-th electrode and the 2n-th electrode, a substance having a higher standard electrode potential can be used for the (2k−1)-th electrode and the (2n−1) electrode, and a substance having a lower standard electrode potential can be used for the 2k-th electrode and the 2n-th electrode.

Electron transfer in a case where the substance having a lower standard electrode potential is used for the (2k−1)-th electrode and the (2n−1)-th electrode and the substance having a higher standard electrode potential is used for the 2k-th electrode and the 2n-th electrode will be described. In the (2k−1)-th electrode and the (2n−1)-th electrode, the metal constituting the electrode is eluted as cations into water of the medium 12, generating free electrons. On the other hand, in the 2k-th electrode and the 2n-th electrode, cations in the medium 12 react with electrons emitted from the electrode into the medium 12, and are electrically neutralized. The free electrons generated at the (2k−1)-th electrode move to the (2n−2)-th electrode, and the free electrons generated at the (2k−1)-th electrode move to the (2k−2)-th electrode. As a result, the electrons move toward the first electrode 1 through the 2n-th electrode, the (2n−1)-th electrode, the 2k-th electrode, and the (2k−1)-th electrode. That is, a current flows from the first electrode 1 toward the electrode having a larger number.

Examples of the substance used for the electrode (negative electrode) having a lower standard electrode potential in the pair of electrodes include Zn, Pb, Cd, Mg, a carbon-based material, a conductive polymer (polythiophene, polyaniline, polypyrrole, polyacetylene, polyphenylenevinylene, PEDOT, etc.), a metal (Li, Sn, Si, Al, Zr, Mg, Ti, etc.) and an alloy thereof, and a metal oxide (titanium oxide, lithium-titanium oxide, silicon oxide, etc.). The standard electrode potential of the substance used for the electrode having a lower standard electrode potential in the pair of electrodes is preferably smaller than or equal to −200 mV, more preferably smaller than or equal to −500 mV, and still more preferably smaller than or equal to −700 mV. In addition, the standard electrode potential of the substance used for the electrode having a lower standard electrode potential is preferably greater than or equal to −3.5 V, more preferably greater than or equal to −2.5 V, and still more preferably greater than or equal to −1.5 V.

On the other hand, examples of the substance used for the electrode (positive electrode) having a higher standard electrode potential in the pair of electrodes include manganese oxide, silver oxide, oxygen, ozone, lead oxide, nickel oxide, nickel hydroxide, nickel oxyhydroxide, copper oxide, chromium oxide, iron oxide, alkali metal or alkaline earth metal, other metals (Co, Ni, Mn, Fe, Mg, Al, etc.), and a carbon-based material. The standard electrode potential of the substance used for the electrode having a higher standard electrode potential in the pair of electrodes is preferably greater than or equal to −300 mV, more preferably greater than or equal to 0 mV, and still more preferably greater than or equal to +500 mV. In addition, the standard electrode potential of the substance used for the electrode having a higher standard electrode potential in the pair of electrodes is preferably smaller than or equal to 3.5 V, more preferably smaller than or equal to 2.5 V, and still more preferably smaller than or equal to 1.5 V.

A difference in standard electrode potential between the respective electrodes of the pair of electrodes is preferably greater than or equal to 200 mV, more preferably greater than or equal to 500 mV, and still more preferably greater than or equal to 700 mV.

The function of the functional part 11 is not particularly limited as long as the functional part 11 executes a predetermined function by energization, for example. The functional part 11 has a function as, for example, a power storage part that stores electricity generated at the electrodes, a control part such as a microcomputer that controls a circuit, or a communication part capable of wirelessly communicating with other devices. In addition, the functional part 11 may have a function as, for example, any of a light source such as an incandescent light bulb or a light emitting diode, a heat generator that emits heat, a sounding body that emits sound, a transmitter that emits a signal, or the like. The functional part 11 may have one of these functions or may have some of these functions.

The medium 12 may be in any form of a gas, a liquid, and a solid. As the medium 12, a medium having no conductivity is preferably used. The gas is not particularly limited as long as it is a gas when used in the present device, and examples of the gas include oxygen, carbon dioxide, nitrogen, hydrogen, and methane. When a gas is used as the medium 12, only a single type of gas may be used, or a mixture of a plurality of types of these gases may be used.

The liquid used as the medium 12 is not particularly limited as long as it is a liquid when used in the present device, and, for example, not only water but also an organic solvent having high polarity, an organic solvent having low polarity, or a non-polar organic solvent can be used. The liquid used as the medium 12 may also be a mixture of water and an organic solvent having high polarity, a mixture of two or more different organic solvents, an emulsion, or the like. As the water, not only pure water but also water containing an electrolyte can be used.

When water is used as the medium 12, the electrolyte concentration of water may be 1 mol/L or less, 0.1 mol/L or less, 0.01 mol/L or less, and 0.001 mol/L or less, or may be 0 mol/L.

As the organic solvent having high polarity, for example, lower alcohols such as methanol and ethanol, lower carboxylic acids such as formic acid and acetic acid, acetone, tetrahydrofuran, dimethyl sulfoxide, and the like can be used. In addition, as the organic solvent having low polarity, higher alcohols such as hexanol and octanol, higher carboxylic acids such as hexanoic acid and octanoic acid, and the like can be used. Examples of the non-polar organic solvent include aliphatic hydrocarbons such as hexane, octane, and nonane, and aromatic compounds such as benzene, toluene, and xylene. When a liquid is used as the medium 12, only a single type of liquid may be used, or a mixture of a plurality of types of these liquids may be used.

The solid used as the medium 12 is not particularly limited as long as it is a solid when used in the present device, and may be, for example, wood, plastic, metal, ceramics, concrete, or the like. As the solid used as the medium 12, for example, a powdery or granular solid such as sand or soil can be used, and a plurality of stones or rocks stacked can also be used. When sand, soil, stones, or rocks stacked on one another are used as the medium 12, fine voids are generated in the medium 12, but even if there are such voids, it is sufficient that the medium 12 is physically in contact.

The medium 12 preferably contains moisture. The water content of the medium 12 such as soil or sand is preferably 3% by mass or more, more preferably 5% by mass or more, still more preferably 10% by mass or more, still more preferably 20% by mass or more, and particularly preferably 30% by mass or more. In addition, the water content of the medium 12 such as soil or sand is preferably 100% by mass or less, more preferably 90% by mass or less, and still more preferably 80% by mass or less. Here, the water content refers to a value obtained by dividing the mass of moisture contained in soil by the sum of the mass of moisture and the mass of a solid content such as soil or sand. For example, the mass of moisture contained in soil is obtained by measuring the mass of soil containing water, drying the soil at 100° C. or higher for 3 minutes or more, and measuring the mass after drying, and is divided by the mass of the soil containing water before drying, so that the water content can be calculated.

The device of the present invention can be formed by using water of, for example, a river, a pond, a sea, or a dam as the medium. Furthermore, the device of the present invention can be formed by using, for example, sand or soil as the medium.

The device according to the present invention can be formed by disposing, in the medium 12 such as water and sand or soil having the above-described water content, a device including the 2n electrodes (n is an integer of 2 or more) from the first electrode to the 2n-th electrode and the functional part, the 2k-th electrode (k is an integer of 1 or more and less than n) being connected to the (2k+1)-th electrode. For example, in a case where n=2, the medium present between the first electrode and the second electrode is defined as the first medium 12a, and the medium present between the third electrode and the fourth electrode is defined as the second medium 12b. In this case, the functional part can be caused to function by arranging the electrodes such that the impedance between the first medium 12a and the second medium 12b is greater than or equal to 5 times the impedance of the first medium 12a present between the first electrode 1 and the second electrode 2, and arranging the electrodes such that the impedance between the first medium 12a and the second medium 12b is greater than or equal to 5 times the impedance of the second medium 12 present between the third electrode 3 and the fourth electrode 4.

In addition, in the above-described device, the device according to the present invention can be formed by disposing, in the medium 12 such as water and sand or soil having the above-described water content, a device including the plurality of pairs of electrodes connected in series to the first electrode 1 and the second electrode 2, and the functional part.

### EXAMPLES

Hereinafter, the present invention will be described in more detail with reference to examples, but the present invention is not limited by these examples at all.

### Example 1

A test was performed at normal temperature and normal pressure. The device including the first electrode 1, the second electrode 2, the third electrode 3, the fourth electrode 4, the functional part 11, and the medium 12, illustrated in FIG. 2B, was used. A bar-shaped member (a diameter of 8 cm and a length of 25 cm) made of magnesium (purity of 99.9% or more) was used as the first electrode 1 and the third electrode 3, and a bar-shaped member (a diameter of 8 cm and a length of 25 cm) made of carbon was used as the second electrode 2 and the fourth electrode 4. An LED bulb was used as the functional part 11. Tap water was used as the medium 12. As a container into which tap water is poured, a transparent acrylic case having a length of 10 cm, a width of 10 cm, and a depth of 20 cm was used.

The first electrode 1 and the second electrode 2 were arranged in one acrylic case so as to have length directions parallel to each other and perpendicular to a horizontal plane, and have a shortest distance of 8 cm. Similarly, the third electrode 3 and the fourth electrode 4 were arranged in another acrylic case so as to have length directions parallel to each other and perpendicular to a horizontal plane, and have a shortest distance of 8 cm. Note that the cases were filled with tap water as the medium up to a height of 10 cm. As a result, the LED bulb had continued to light up for at least 24 hours or more.

### Example 2

A test was performed at normal temperature and normal pressure. The device including the first electrode 1, the second electrode 2, the third electrode 3, the fourth electrode 4, the fifth electrode 5, the sixth electrode 6, the functional part 11, and the medium 12, illustrated in FIG. 3, was used. A bar-shaped member (a diameter of 8 cm and a length of 25 cm) made of magnesium (purity of 99.9% or more) was used as the first electrode 1, the third electrode 3, and the fifth electrode 5, and a bar-shaped member (a diameter of 8 cm and a length of 25 cm) made of carbon was used as the second electrode 2, the fourth electrode 4, and the sixth electrode 6. An LED bulb was used as the functional part 11. Tap water was used as the medium 12. As a container into which tap water is poured, a transparent acrylic case having a length of 10 cm, a width of 10 cm, and a depth of 20 cm was used.

The first electrode 1 and the second electrode 2 were arranged in one acrylic case so as to have length directions parallel to each other and perpendicular to a horizontal plane, and have a shortest distance of 8 cm. Similarly, the third electrode 3 and the fourth electrode 4 were arranged in another acrylic case so as to have length directions parallel to each other and perpendicular to a horizontal plane, and have a shortest distance of 8 cm. Furthermore, the fifth electrode 5 and the sixth electrode 6 were arranged in an acrylic case different from the above two acrylic cases so as to have length directions parallel to each other and perpendicular to a horizontal plane, and have a shortest distance of 8 cm. Note that the cases were filled with tap water as the medium up to a height of 10 cm. As a result, the LED bulb had continued to light up for at least 24 hours or more.

### Comparative Example 1

A test was performed at normal temperature and normal pressure. A device including the first electrode 1, the second electrode 2, the functional part 11, and the medium 12 was used. A bar-shaped member (a diameter of 8 cm and a length of 25 cm) made of magnesium (purity of 99.9% or more) was used as the first electrode 1, and a bar-shaped member (a diameter of 8 cm and a length of 25 cm) made of carbon was used as the second electrode 2. An LED bulb was used as the functional part 11. Tap water was used as the medium 12. As a container into which tap water is poured, a transparent acrylic case having a length of 10 cm, a width of 10 cm, and a depth of 20 cm was used.

One terminal of the LED bulb was connected to the first electrode 1, and the other terminal of the LED bulb was connected to the second electrode 2. The first electrode 1 and the second electrode 2 were arranged in the acrylic case so as to have length directions parallel to each other and perpendicular to a horizontal plane, and have a shortest distance of 8 cm. The case was filled with water as the medium up to a height of 10 cm. However, the LED bulb did not light up.

### Example 3

A test was performed at normal temperature and normal pressure. The device including the first electrode 1, the second electrode 2, the third electrode 3, the fourth electrode 4, the functional part 11, and the medium 12, illustrated in FIG. 2A, was used. A bar-shaped member (a diameter of 8 cm and a length of 25 cm) made of magnesium (purity of 99.9% or more) was used as the first electrode 1 and the third electrode 3, and a bar-shaped member (a diameter of 8 cm and a length of 25 cm) made of carbon was used as the second electrode 2 and the fourth electrode 4. An LED bulb was used as the functional part 11. Moisture-containing soil (a water content of 3% or more) was used as the medium 12. As a container filled with soil, a wooden box having an inner diameter of 83 mm in length and 855 mm in width, and a depth of 20 cm was used.

The first electrode 1 and the second electrode 2 were arranged so as to have length directions parallel to each other and perpendicular to a horizontal plane, and have a shortest distance of 2 cm. Similarly, the third electrode 3 and the fourth electrode 4 were arranged so as to have length directions parallel to each other and perpendicular to a horizontal plane, and have a shortest distance of 2 cm. The pair of the first electrode 1 and the second electrode 2 and the pair of the third electrode 3 and the fourth electrode 4 were arranged so as to have a shortest distance of 35 cm. Note that the box was filled with soil as the medium up to a height of 10 cm. As a result, the LED bulb had continued to light up for at least 24 hours or more.

In the device of Example 3, a potentiostat (SP-200 manufactured by Bio-Logic Sciences Instruments) was connected instead of the LED bulb of the functional part 11, and a load current of 0.1 mA was applied by the potentiostat. As a result, a voltage between the first electrode 1 and the fourth electrode was 2.6 V.

By the way, an impedance of the above soil in each of the cases where a distance between electrodes was 2 cm and 35 cm was measured using the potentiostat (measured by setting a distance between the carbon electrode and the carbon electrode to 2 cm or 35 cm). The impedance was 0.74 kΩ when the distance between the electrodes was 2 cm, and the impedance was 222 kΩ when the distance between the electrodes was 35 cm. That is, the impedance of the medium between the pair of the first electrode 1 and the second electrode 2 and the pair of the third electrode 3 and the fourth electrode 4 was found to be 300 times (=222/0.74) the impedance of the medium between the first electrode 1 and the second electrode 2 and the impedance of the medium between the third electrode 3 and the fourth electrode 4.

### Example 4

The same device as in Example 3 was configured except that the pair of the first electrode 1 and the second electrode 2 and the pair of the third electrode 3 and the fourth electrode 4 were arranged so as to have a shortest distance of 70 cm. As a result, the LED bulb had continued to light up for at least 24 hours or more.

In the device of Example 4, a potentiostat (SP-200 manufactured by Bio-Logic Sciences Instruments) was connected instead of the LED bulb of the functional part 11, and a load current of 0.1 mA was applied by the potentiostat. As a result, a voltage between the first electrode 1 and the fourth electrode was 2.9 V.

By the way, an impedance of the above soil in each case where a distance between electrodes was 70 cm was measured using the potentiostat (measured by setting a distance between a carbon electrode and a carbon electrode to 70 cm). The impedance was 1130 kΩ. That is, the impedance of the medium between the pair of the first electrode 1 and the second electrode 2 and the pair of the third electrode 3 and the fourth electrode 4 was found to be about 1527 times (=1130/0.74) the impedance of the medium between the first electrode 1 and the second electrode 2 and the impedance of the medium between the third electrode 3 and the fourth electrode 4.

### Comparative Example 2

The same device as in Example 3 was configured except that the first electrode 1 and the second electrode 2 were arranged so as to have a shortest distance of 10 cm and the third electrode 3 and the fourth electrode 4 were arranged so as to have a shortest distance of 10 cm. However, the LED bulb did not light up.

### Example 5

A test was performed at normal temperature and normal pressure. The device including the first electrode 1, the second electrode 2, the third electrode 3, the fourth electrode 4, the fifth electrode 5, the sixth electrode 6, the functional part 11, and the medium 12, illustrated in FIG. 3, was used. A bar-shaped member (a diameter of 8 cm and a length of 25 cm) made of magnesium (purity of 99.9% or more) was used as the first electrode 1, the third electrode 3, and the fifth electrode 5, and a bar-shaped member (a diameter of 8 cm and a length of 25 cm) made of carbon was used as the second electrode 2, the fourth electrode 4, and the sixth electrode 6. An LED bulb was used as the functional part 11. Moisture-containing soil (a water content of 3% or more) was used as the medium 12. As a container filled with soil, a wooden box having an inner diameter of 83 mm in length and 855 mm in width, and a depth of 20 cm was used.

The first electrode 1 and the second electrode 2 were arranged so as to have length directions parallel to each other and perpendicular to a horizontal plane, and have a shortest distance of 2 cm. Similarly, the third electrode 3 and the fourth electrode 4 were arranged so as to have length directions parallel to each other and perpendicular to a horizontal plane, and have a shortest distance of 2 cm. The fifth electrode 5 and the sixth electrode 6 were arranged so as to have length directions parallel to each other and perpendicular to a horizontal plane, and have a shortest distance of 2 cm. The pair of the first electrode 1 and the second electrode 2 and the pair of the third electrode 3 and the fourth electrode 4 were arranged so as to have a shortest distance of 35 cm, and the pair of the third electrode 3 and the fourth electrode 4 and the pair of the fifth electrode 5 and the sixth electrode 6 were arranged so as to have a shortest distance of 35 cm. That is, the pair of the third electrode 3 and the fourth electrode 4 was arranged so as to be located at the center of the other pairs of electrodes. Note that the box was filled with soil as the medium up to a height of 10 cm. As a result, the LED bulb had continued to light up for at least 24 hours or more.

### Comparative Example 3

A test was performed at normal temperature and normal pressure. A device including the first electrode 1, the second electrode 2, the functional part 11, and the medium 12 was used. A bar-shaped member (a diameter of 8 cm and a length of 25 cm) made of magnesium (purity of 99.9% or more) was used as the first electrode 1, and a bar-shaped member (a diameter of 8 cm and a length of 25 cm) made of carbon was used as the second electrode 2. An LED bulb was used as the functional part 11. Moisture-containing soil (a water content of 3% or more) was used as the medium 12. As a container filled with soil, a wooden box having an inner diameter of 83 mm in length and 855 mm in width, and a depth of 20 cm was used.

One terminal of the LED bulb was connected to the first electrode 1, and the other terminal of the LED bulb was connected to the second electrode 2. The first electrode 1 and the second electrode 2 were arranged in the wooden box so as to have length directions parallel to each other and perpendicular to a horizontal plane, and have a shortest distance of 2 cm. The box was filled with soil as the medium up to a height of 10 cm. However, the LED bulb did not light up.

### REFERENCE SIGNS LIST

1 First electrode
2 Second electrode
3 Third electrode
4 Fourth electrode
5 Fifth electrode
6 Sixth electrode
11 Functional part
12 Medium

1. A device comprising:
2n electrodes (n is an integer of 2 or more) from a first electrode to a 2n-th electrode; and
a medium present between a (2k−1)-th electrode (k is an integer of 1 or more and less than n) and a 2k-th electrode and between a (2n−1)-th electrode and the 2n-th electrode, wherein
the 2k-th electrode is connected to a (2k+1)-th electrode, and
an impedance between a point in the medium between the (2k−1)-th electrode and the 2k-th electrode and a point in the medium between the (2k+1)-th electrode and a (2k+2)-th electrode is greater than or equal to 5 times each of an impedance between the (2k−1)-th electrode and the 2k-th electrode and an impedance between the (2k+1)-th electrode and the (2k+2)-th electrode.

2. The device according to claim 1, wherein a substance constituting the (2k−1)-th electrode and/or the (2n−1)-th electrode has a standard electrode potential different from a standard electrode potential of a substance constituting the 2k-th electrode and/or the 2n-th electrode.

3. The device according to claim 1, wherein a distance between the point in the medium between the (2k−1)-th electrode and the 2k-th electrode and the point in the medium between the (2k+1)-th electrode and the (2k+2)-th electrode is greater than or equal to 5 times each of a distance between the (2k−1)-th electrode and the 2k-th electrode and a distance between the (2k+1)-th electrode and the (2k+2)-th electrode.

4. The device according to claim 1, wherein the medium is water.

5. The device according to claim 4, wherein the medium has an electrolyte concentration of 1.0 mol/1 or less.

6. The device according to claim 1, wherein the medium is soil or sand having a water content of 3% by mass or more.

7. A device comprising:
2n electrodes (n is an integer of 2 or more) from a first electrode to a 2n-th electrode; and a functional part, wherein
when a 2k-th electrode (k is an integer of 1 or more and less than n) is connected to a (2k+1)-th electrode, a medium is present between a (2k−1)-th electrode and the 2k-th electrode, and a medium is present between the (2k+1)-th electrode and a (2k+2)-th electrode,
the functional part functions when an impedance between a point in the medium between the (2k−1)-th electrode and the 2k-th electrode and a point in the medium between the (2k+1)-th electrode and the (2k+2)-th electrode is made greater than or equal to 5 times each of an impedance between the (2k−1)-th electrode and the 2k-th electrode and an impedance between the (2k+1)-th electrode and the (2k+2)-th electrode.

8. A method of causing a device to function, the device including 2n electrodes (n is an integer of 2 or more) from a first electrode to a 2n-th electrode, and a functional part, the method comprising,
when a 2k-th electrode (k is an integer of 1 or more and less than n) is connected to a (2k+1)-th electrode, a medium is present between a (2k−1)-th electrode and the 2k-th electrode, and a medium is present between the (2k+1)-th electrode and a (2k+2)-th electrode,
causing the functional part to function when an impedance between a point in the medium between the (2k−1)-th electrode and the 2k-th electrode and a point in the medium between the (2k+1)-th electrode and the (2k+2)-th electrode is made greater than or equal to 5 times each of an impedance between the (2k−1)-th electrode and the 2k-th electrode and an impedance between the (2k+1)-th electrode and the (2k+2)-th electrode.

9. A device comprising:
2n electrodes (n is an integer of 2 or more) from a first electrode to a 2n-th electrode; and
a medium present between a (2k−1)-th electrode (k is an integer of 1 or more and less than n) and a 2k-th electrode and between a (2n−1)-th electrode and the 2n-th electrode, wherein
the 2k-th electrode is connected to a (2k+1)-th electrode, and
a distance between a point in the medium between the (2k−1)-th electrode and the 2k-th electrode and a point in the medium between the (2k+1)-th electrode and a (2k+2)-th electrode is greater than or equal to 5 times each of a distance between the (2k−1)-th electrode and the 2k-th electrode and a distance between the (2k+1)-th electrode and the (2k+2)-th electrode.

10. A device comprising:
2n electrodes (n is an integer of 2 or more) from a first electrode to a 2n-th electrode; and a functional part, wherein
when a 2k-th electrode (k is an integer of 1 or more and less than n) is connected to a (2k+1)-th electrode, a medium is present between a (2k−1)-th electrode and the 2k-th electrode, and a medium is present between the (2k+1)-th electrode and a (2k+2)-th electrode,
the functional part functions when a distance between a point in the medium between the (2k−1)-th electrode and the 2k-th electrode and a point in the medium between the (2k+1)-th electrode and the (2k+2)-th electrode is made greater than or equal to times each of a distance between the (2k−1)-th electrode and the 2k-th electrode and a distance between the (2k+1)-th electrode and the (2k+2)-th electrode.

11. A method of causing a device to function, the device including 2n electrodes (n is an integer of 2 or more) from a first electrode to a 2n-th electrode, and a functional part, the method comprising,
when a 2k-th electrode (k is an integer of 1 or more and less than n) is connected to a (2k+1)-th electrode, a medium is present between a (2k−1)-th electrode and the 2k-th electrode, and a medium is present between the (2k+1)-th electrode and a (2k+2)-th electrode,
causing the functional part to function when a distance between a point in the medium between the (2k−1)-th electrode and the 2k-th electrode and a point in the medium between the (2k+1)-th electrode and the (2k+2)-th electrode is made greater than or equal to 5 times each of a distance between the (2k−1)-th electrode and the 2k-th electrode and a distance between the (2k+1)-th electrode and the (2k+2)-th electrode.

12. The device according to claim 1, wherein n is 2.

13. The device according to claim 7, wherein n is 2.

14. The method according to claim 8, wherein n is 2.
